(19) United States
(12) Patent Application Publication
(10) Pub. No.: US 2013/0254742 A1
(43) Pub. Date: Sep. 26, 2013

(54) Software Portfolio Management Based on Feature Usage

(71) Applicant: INTERNATIONAL BUSINESS MACHINES CORPORATION, (US)

(72) Inventors: Christopher John Hockings, Burleigh Waters (AU); Neil Ian Readshaw, Parkwood (AU)

(73) Assignee: INTERNATIONAL BUSINESS MACHINES CORPORATION, Armonk, NY (US)

(21) Appl. No.: 13/746,355

(22) Filed: Jan. 22, 2013

Related U.S. Application Data
(63) Continuation of application No. 13/426,735, filed on Mar. 22, 2012.

(51) Int. Cl. G06F 9/44

(52) U.S. Cl. CPC G06F 8/70
USPC 717/120

(57) ABSTRACT

An approach is provided to gather items of usage data that pertain a number of instrumented software modules that are included in a software offering. The usage data is gathered from a number of customer installations of the software offering. Usage statistics are computed for the software modules and are used to determine support levels for the instrumented software modules. In another aspect, an approach is provided that detects execution of the software modules included in a software offering. Usage statistics are recorded in a local data store. One of the usage statistics is a module identifier that the software module that was executed. In addition, the usage statistics track the number of times each of the software modules was executed. The usage statistics are periodically transmitting a computer network to a software provider that develops and maintains the software offering.

### TECHNICAL FIELD

The present disclosure relates to an approach that tracks usage of software product features. More particularly, the present disclosure relates to an approach that provides usage data pertaining to software features to the software provider for development and maintenance considerations.

### BACKGROUND OF THE INVENTION

Software companies deliver offerings that are either “bespoke” or “reusable.” Bespoke offerings are typically designed and delivered to a single customer whereas reusable offerings are typically designed and delivered to multiple customers. In the case of reusable software offerings, these offerings may be provided as software to be installed on a customer's premises, or in a software-as-a-service offering in a public or hybrid cloud, for example. It is also common in the software industry for bespoke offerings to become more reusable as software companies attempt to maximize their investment. If a reusable software offering is successful, it accumulates customers over time. It also accumulates features and capabilities that are usually maintained to preserve backwards compatibility. The cost of implementing different features will vary based on the design, code, test, support, and maintenance. The value to the customer base will also vary, according to how many customers use a particular feature and the impact to those customers if that feature was not present in the software offering. Over time, a successful software offering usually ends with a number of product features and capabilities that require continual investment and maintenance. This is often at the expense of creating new features as market requirements change. There is also an increased risk when implementing new features, as these features may cause regression of current functionality.

### SUMMARY

An approach is provided to gather items of usage data that pertain a number of instrumented software modules that are included in a software offering. The usage data is gathered by a software provider from a number of customer installations of the software offering. Usage statistics are computed for the instrumented software modules and these usage statistics are used to determine a support level for the instrumented software modules, such as might be used in a software product maintenance and development plan.

In another aspect, an approach is provided that detects the execution of the various software modules that are included in a software offering, such as at a customer installation. Usage statistics pertaining to each of the detected executions of the software module are recorded in a local data store. One of the usage statistics is a module identifier that the software module that was executed. In addition, the usage statistics keep track of the number of times each of the software modules was executed. The usage statistics are then periodically transmitting a computer network to a software provider that develops and maintains the software offering.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a block diagram depicting customer usage data pertaining to a software offering being gathered and returned to the software provider;

FIG. 4 is a diagram depicting instrumented software modules providing usage data which is gathered and transmitted back to the software provider;

FIG. 5 is a flowchart showing steps performed by module instrumentation when a module in the software offering is executed;

FIG. 6 is a flowchart showing steps performed by the feature use analysis process;

FIG. 7 is a flowchart showing steps performed in gathering usage data from customers using a “pull” methodology;

FIG. 8 is a flowchart showing steps performed in gathering usage data from customers using a “push” methodology; and

FIG. 9 is a flowchart showing steps performed by product development and maintenance in response to the collected customer usage data.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

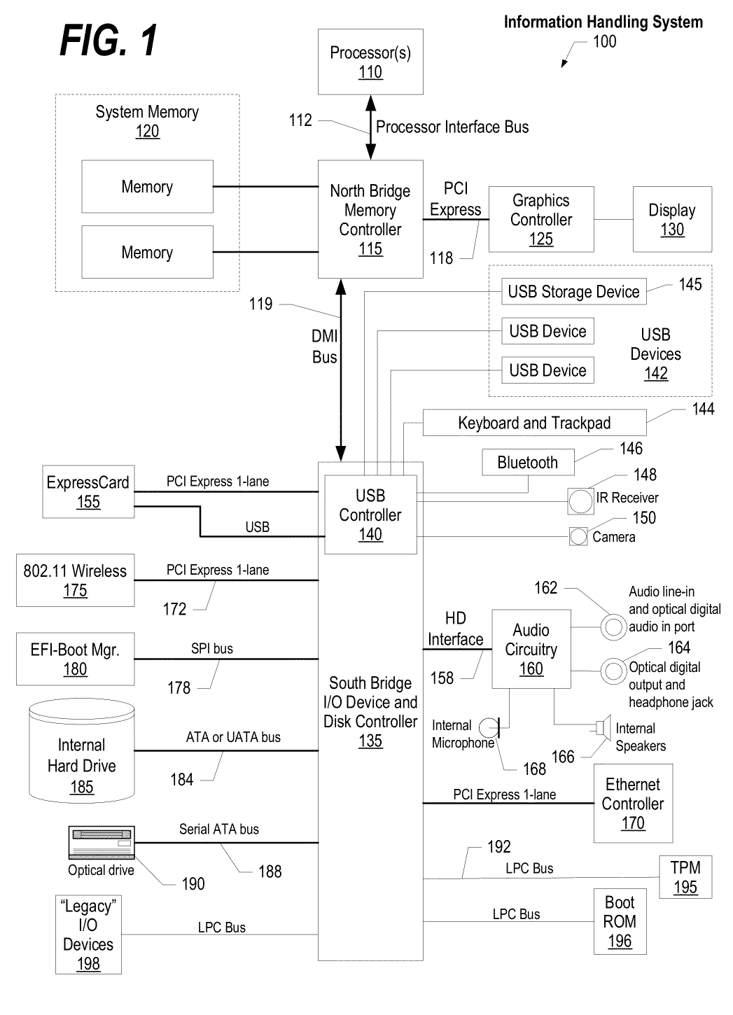

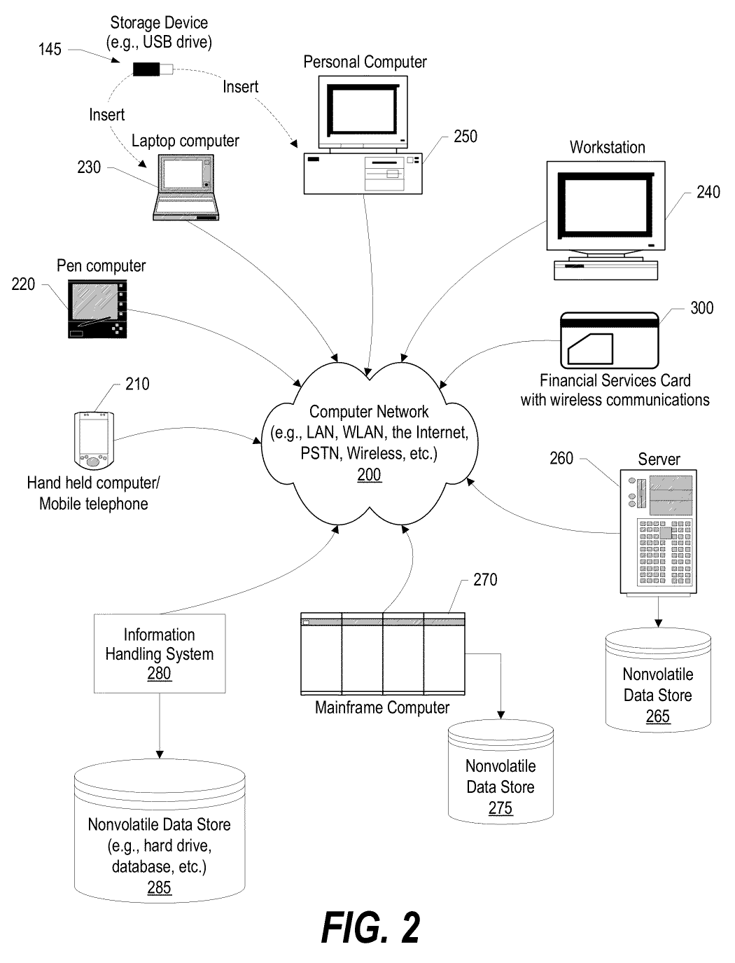

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 0.802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

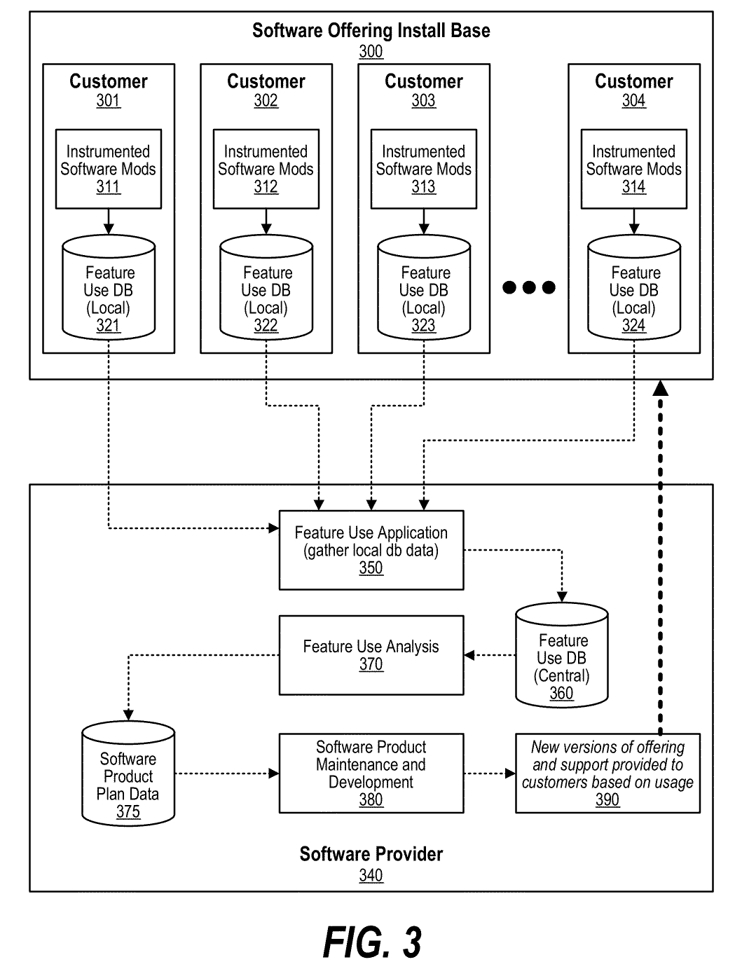

FIG. 3 is a block diagram depicting customer usage data pertaining to a software offering being gathered and returned to the software provider. A software offering is installed at a number of customer installations, collectively shown as install base 300. An install base can either be an installation on a customer's information handling system, such as a mainframe computer system, a set of networked desktop or personal computer systems, or any combination or type of information handling systems that are owned or leased by the customer. In addition, the software offering can be a “cloud-based” offering where the software offering is delivered as a service rather than a product with fees often based on a subscription or using metered service over a computer network, such as the Internet.

Install base 300 shows a number of different customer installations of the software offering. The customers include customers 301, 302, 303, and 304. In each of these installations, software modules that make up the software offering are instrumented in order to track usage of the various modules. The instrumented software modules depicted are 311, 312, 313, and 314 for customer installations 301, 302, 303, and 304, respectively. When software modules are executed, usage data pertaining to the execution (e.g., module identifier, timestamp, user, etc.) are stored in a local use data store. The local use data stores depicted in the customer base are 321, 322, 323, and 324 for customer installations 301, 302, 303, and 304, respectively. Periodically, the local usage data is transmitted to software provider 340 over a computer network, such as the Internet. In one embodiment, the usage data is “pushed” from the various customer installations to the software provider (e.g., when data is gathered, at scheduled times, etc.). In another embodiment, the usage data is “pulled” by software provider 340 (e.g., when requested by a product planner, at scheduled times, etc.).

Software provider 340 utilizes various processes to gather and analyze usage data received from customer installations. Process 350 is a feature use application that gathers usage data from the various customer installation data stores and stores the usage data in feature use data store 360 which is a centralized data store that aggregates all of the various customer usage data. Feature use analysis process 370 analyzes the feature usage data in order to develop the software provider's software product maintenance and development plan 375. The software product maintenance and development plan are used by the software provider's Software Product Maintenance and Development personnel 380 in order to develop new, updated, versions of the software offering 390 and in order to provide different levels of support. The support and new versions of the software offering are then provided back to install base 300 (e.g., installed at the various customer installations, etc.).

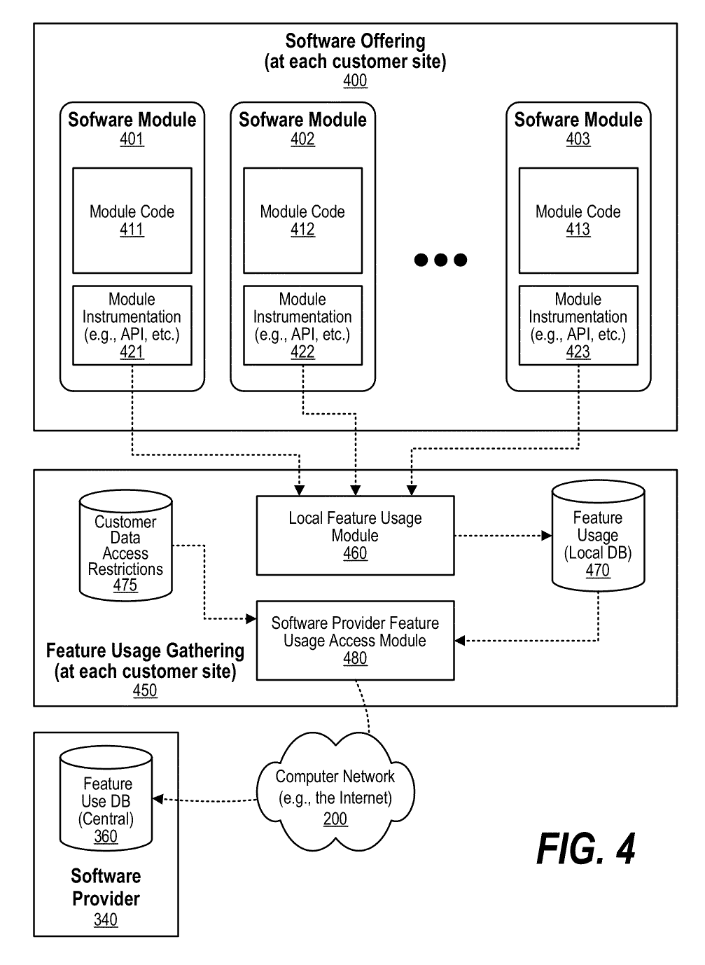

FIG. 4 is a diagram depicting instrumented software modules providing usage data which is gathered and transmitted back to the software provider. Customer installation 400 depicts the software offering installed at a particular customer and utilized by the customer either in a cloud-based installation or in a traditional installation where the software modules that comprise the software offering are installed on the customer's information handling systems. The software offering includes any number of software modules (software modules 401, 402, and 403). Each software module includes module code (module code 411, 412, and 413 correspond to software modules 401, 402, and 403, respectively). The software code may be compiled (e.g., object code, etc.) or can be any other type of functional descriptive material that is executable by a computer system. Other types of software code include interpreted code, bytecode, etc. In addition, each software module includes module instrumentation which gathers usage data when the software module is executed. The module instrumentation may be a call (e.g., Application Programming Interface (API), etc.) to an instrumentation routine that records the desired usage data. Examples of usage data include the module identifier that uniquely identifies the software module that is being executed, time/date information (e.g., a timestamp, etc.), the user identifier of the user that is executing the software module, and any other usage data that may be of interest to the software provider. In FIG. 4, module instrumentation 421, 422, and 423 are associated with module code 411, 412, and 413, respectively. So, when module instrumentation 421 is invoked, the module instrumentation is responsible for recording the fact that module code 411 (e.g., the module identifier associated with module code 411, etc.) was executed at a particular time along with other usage data.

In one embodiment, the customer installation includes feature usage gathering subsystem 450 which has components to receive usage data, store the data, and periodically provide usage data to the software provider. Feature usage gathering subsystem 450 includes local feature usage module 460 which receives the calls from the various module instrumentation (module instrumentation 421, 422, and 423) and records the pertinent usage data in feature usage local data store 470. In one embodiment, the customer can optionally set customer data access restrictions which are stored in restrictions data store 475. These restrictions allow the customer to control the types of usage data that is provided to the software provider. For example, if the usage data includes the user identifier of the user that was using the software offering when the software module was called, the customer may wish to block this usage data from being transmitted to the software provider. However, the customer may wish to retain this data in the local usage data store 470 for internal tracking purposes. For example, if the software provider decides to discontinue a particular software module due to low usage among the provider's overall customer base, the various customers would be able to check if any of their employees or authorized users are utilizing the particular software module and take corrective action (e.g., notifying the particular users that the software module is being eliminated and provide the particular users with alternatives, such as new features/modules included in the software offering that may accomplish the same task, etc.).

In the embodiment discussed above, the usage data that is gathered and stored in local data store 470 is periodically transmitted to software provider 340 using Software Provider Feature Usage Access Module 480. Module 480 is a process that can be implemented as either a “push” or “pull” style of transmission. In a “push” implementation, module 480 periodically pushes (transmits) the local usage data to software provider 340 (e.g., when a particular amount of data has been stored in data store 470, after a period of time has elapsed, such as hourly, daily, etc.). In a “pull” implementation, software provider 340 periodically requests the usage data from the various customer installations and, when module 480 receives the request, the customer installation responds by having module 480 transmit the local usage data stored in data store 470 to the software provider. The usage data is transmitted to software provider 340 via computer network 200, such as the Internet. Once received at the software provider, the usage data is aggregated in central feature use data store 360 for further analysis.

In an alternative embodiment, rather than storing the usage data on a local data store, the various module instrumentation can call a routine hosted by software provider 340 so that the usage data is stored at the software provider rather than being stored locally at the customer installation. For example, in a cloud-based implementation, the software provider may provide the cloud-based software offering so that when modules are called the instrumentation records the module identifier and other usage data directly to a cloud-based data store that is controlled by the software provider.

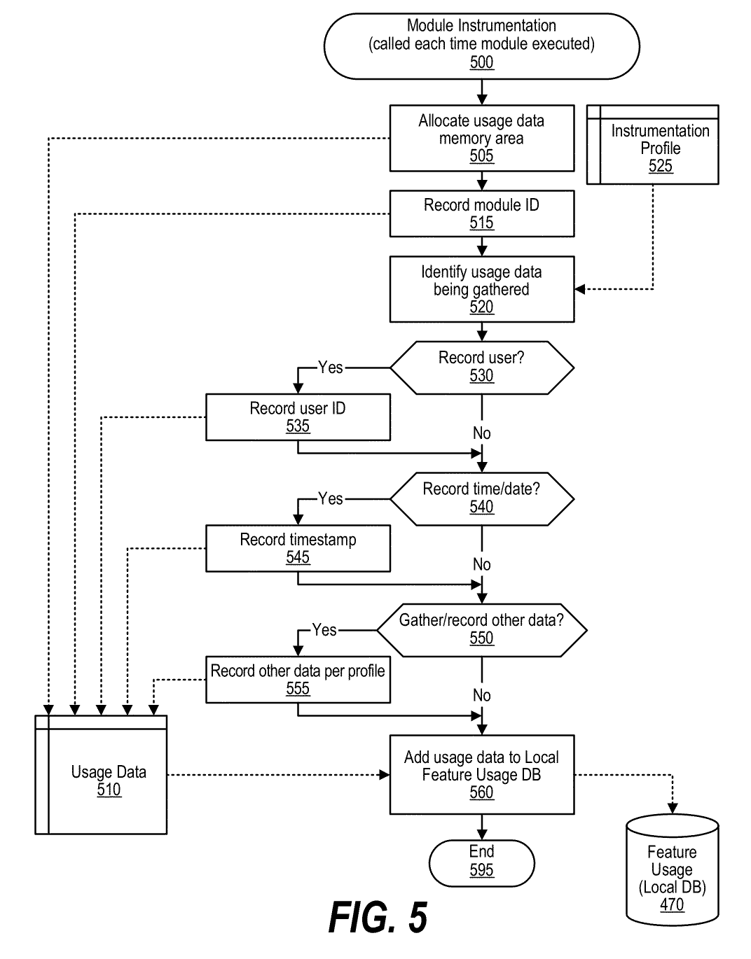

FIG. 5 is a flowchart showing steps performed by module instrumentation when a module in the software offering is executed. Processing commences at 500 whereupon, at step 505, memory area 510 is allocated in order to store usage data. At step 515, the module identifier of the software module that has been invoked is recorded in memory area 510. At step 520, instrumentation profile 525 is accessed to identify the usage data items that are being recorded. In this manner, the software provider and/or the customer can control what types of data are collected when a module is executed. For example, the customer may not wish to have the user identifier of the user that is executing the software module gathered as part of the usage data.

A decision is made as to whether the instrumentation is gathering the user identifier of the user that has executed the software module (decision 530). If the instrumentation profile indicates that the user identifier is being gathered, then decision 530 branches to the “yes” branch whereupon, at step 535, the user identifier of the user that is executing the software module is recorded (written) to usage data memory 510. On the other hand, if the user identifier is not being gathered, then decision 530 branches to the “no” branch bypassing step 535.

A decision is made as to whether the instrumentation is gathering the time and data at which the software module was executed (decision 540). If the instrumentation profile indicates that the time/date is being gathered, then decision 540 branches to the “yes” branch whereupon, at step 545, the current timestamp is recorded (written) to usage data memory 510 indicating the date and time at which the software module was executed. On the other hand, if the time/date is not being gathered, then decision 540 branches to the “no” branch bypassing step 545.

A decision is made as to whether the instrumentation is gathering any other data pertaining to this execution of the software module (decision 550). If the instrumentation profile indicates that additional data is being gathered, then decision 550 branches to the “yes” branch whereupon, at step 555, the additional data pertaining to this execution of the software module is recorded (written) to usage data memory 510. On the other hand, if additional data is not being gathered, then decision 550 branches to the “no” branch bypassing step 555.

After the usage data pertaining to the current execution of the software module has been gathered and stored in memory area 510, step 560 operates to add the gathered usage data to local usage data store 470. The invocation of the module instrumentation routine thereafter ends at 595.

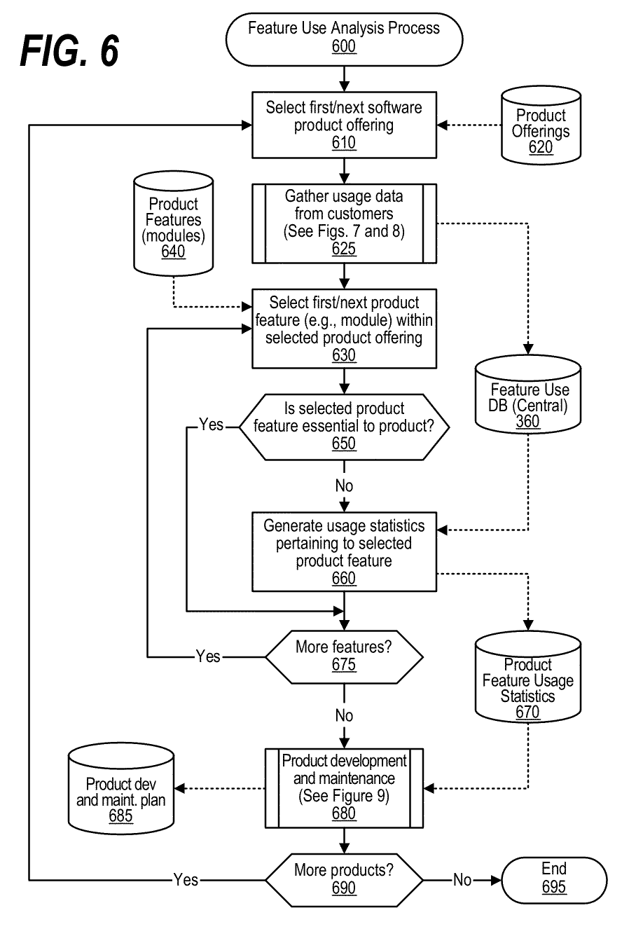

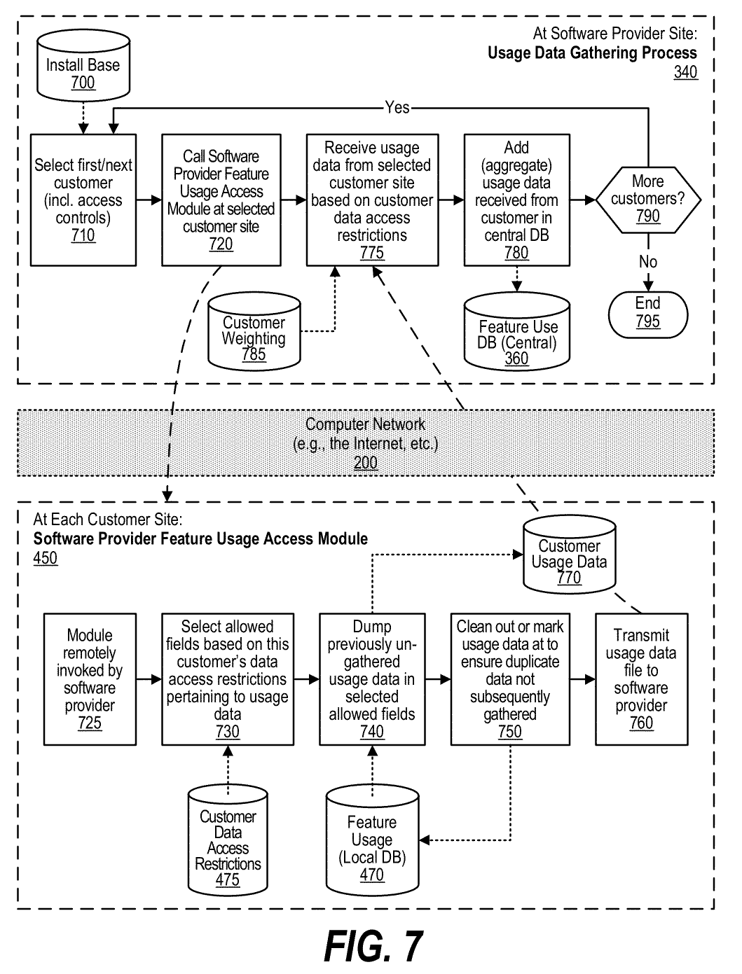

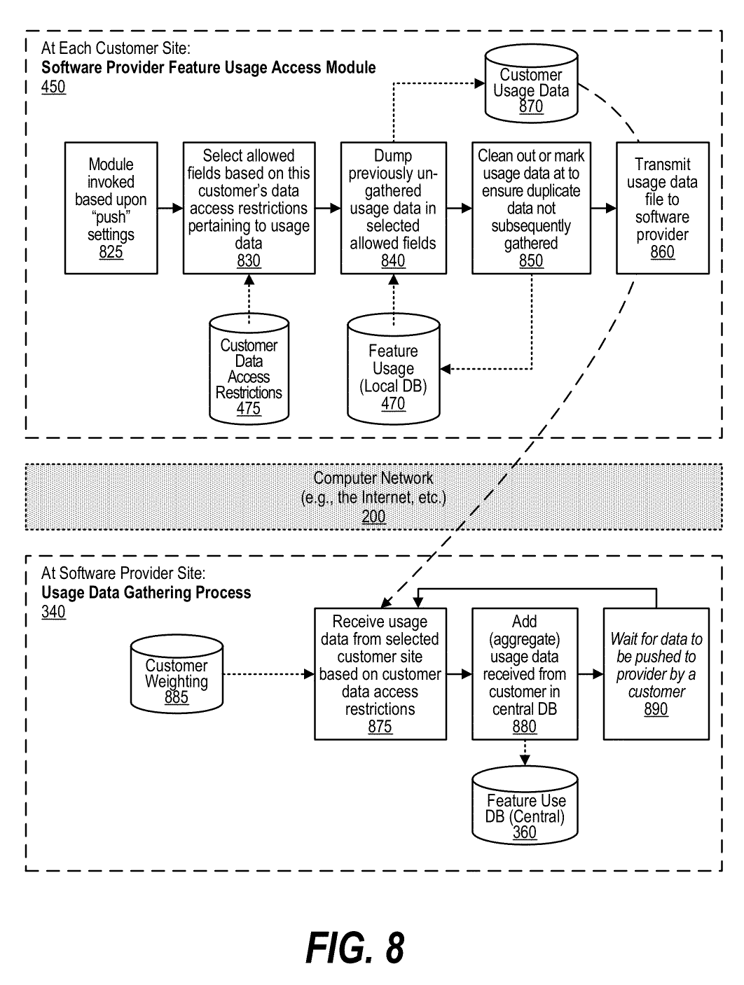

FIG. 6 is a flowchart showing steps performed by the feature use analysis process. Processing commences at 600 whereupon, at step 610, the software provider selects its first software product offering from product offerings data store 620. At predefined process 625, data is gathered from the customer install base for the selected product offering (see FIGS. 7 and 8). FIG. 7 depicts a “pull” methodology where the usage data is pulled by the software provider from the various customer installations. FIG. 8 depicts use of a “push” methodology where the customer installations “push” the data to the software provider (e.g., when data is recorded in the customer's local usage data store, on a periodic basis, etc.). Regardless of whether a “push” or “pull” methodology is used, the result will be update of central feature usage data store 360 which includes usage data from all of the various customer installation where the selected product offering is installed. As previously mentioned, the actual customer installation may be a cloud-based service installation where the customer accesses and uses the software offering that is stored in a “cloud” that is hosted by the software provider or other third party. In addition, the actual customer installation may be the more traditional software installation on one or more information handling systems used by the customer to manage their business (e.g., mainframe system, networked personal computer systems/workstations, etc.).

At step 630, the feature use analysis process selects the first product feature (e.g., instrumented software module, etc.) within the selected product offering. The list of product features (modules) is stored in product features data store 640. In addition, the list of product features notes which software features are essential to the product (e.g., kernel features or otherwise required to be part of the software product offering, etc.). A decision is made as to whether the selected product feature is essential to the software product offering (decision 650). If the selected product feature is not essential to the product (e.g., the software product offering can operate if the feature is removed from the product, etc.), then decision 650 branches to the “no” branch whereupon, at step 660, customer usage statistics are computed for the selected software feature based upon the actual customer usage data that was gathered and compiled in central feature usage data store 360. The resulting product feature usage statistics are stored in data store 670. The usage statistics include the software module identifiers and aggregated usage data, such as number of times a feature was used by customers. Other usage statistics may include the amount of time customers spend using the particular feature. Returning to decision 650, if the selected product feature is essential to the software product offering, then decision 650 branches to the “yes” branch bypassing step 660.

A decision is made as to whether there are more features to analyze for the selected software product offering (decision 675). If there are more product features (modules) to analyze, then decision 675 branches to the “yes” branch which loops back to select the next product feature within the selected software product offering and process it as described above. This looping continues until there are no more product features (modules) to process, at which point decision 675 branches to the “no” branch.

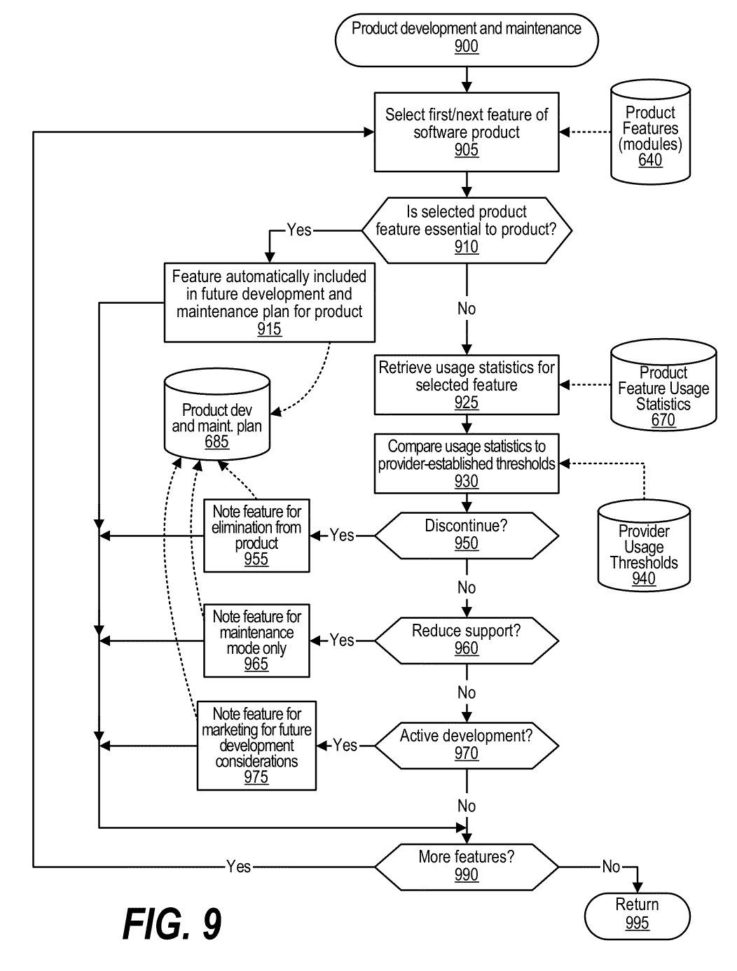

At predefined process 680, a product development and maintenance process is performed in order to develop the software provider's product development and maintenance plan for the selected software product offering (see FIG. 9 and corresponding text for processing details). The product development and maintenance plan is stored in data store 685 and suggests software features (modules) that are not widely used by the customers of the software product offering and that, therefore, can be eliminated or have reduced maintenance and support provided for the software feature. In this manner, the software provider's resources (programmers, engineers, developers, etc.) can be more focused on developing new features and providing better maintenance and support for those software features that are more popular and are more widely used by the customer base.

A decision is made as to whether the software provider has more software product offerings that need to be analyzed as discussed above (decision 690). If the software provider has more software product offerings that need to be analyzed, then decision 690 branches to the “yes” branch which loops back to select and process the next software product offering as described above. This looping continues until all of the software provider's software product offerings have been processed, at which point decision 690 branches to the “no” branch at which point the software provider's feature use analysis process ends at 695.

FIG. 7 is a flowchart showing steps performed in gathering usage data from customers using a “pull” methodology. Software provider processing 340 commences at 710 at which point the software provider selects the first customer from install base data store 700. The selection of the customer includes retrieval of the access controls needed to request transmission of the product usage data stored on the customer installation (e.g., a network address to which to direct the request, etc.). At step 720, the software provider calls the software provider feature usage access module installed at the selected customer installation (e.g., by sending a request to the retrieved network address, etc. through computer network 200, such as the Internet).

Software provider feature usage access module processing 450 running at the customer installation commences at 725 when the usage access module is remotely invoked by the software provider's call to the module. At step 730, the software provider feature usage access module selects usage fields from data access restrictions data store 475. Data access restrictions data store 475 is a list of those usage access fields that are restricted from being sent to the software provider. For example, the usage data may gather the user identifiers of the users that execute various software modules included in the software offering and the customer may not wish to share this more personal information with the software provider. However, the customer may wish the retain this sensitive information locally as it may be useful for internal tracking and also in order to contact its users that have been shown to utilize software features (modules) that are scheduled to be eliminated or have reduced support. At step 740, the usage access module dumps previously un-gathered usage data from the local usage data store 470 to a customer usage data store 770 according to the customer's data access restrictions (e.g., refraining from sending user identifiers to the software provider, etc.). At step 750, the usage access module cleans out the local feature usage data store 470 or otherwise marks those data records that have already been transmitted to the software provider in order to reduce or eliminate duplicate data from being sent to the software provider. At step 760, the usage access module running on the customer's installation sends customer usage data store 770 to the software provider (e.g., over computer network 200, such as the Internet).

Returning to processing performed at the software provider's site, at step 775, the software provider receives the usage data that was gathered at the customer's installation and has been redacted based on the customer's data access restrictions. In one embodiment, the data received by the customer is “weighted” based upon some criteria important to the software provider, such as the strategic value, or importance, of the customer to the software provider. In this embodiment, the weighting value could be automatically computed based upon customer support revenue or “net new license revenue over some time period”. In this manner, if one strategic customer is using a feature, product management would not want to remove it and the weighting value received from customer weighting values data store 785 would add value to the data stored in feature usage data store 470. For example, a large, important customer may have its usage data multiplied by a particular factor (e.g., double or triple less important customers, etc.). Additionally, if only one small customer is using a particular feature, the usage by the less important customer would be recognized as being less strategic for inclusion in later releases because of the lower customer weighting value attributed to the customer. Moreover, a customer weighting value that is based on financial aspects to the software provider would reflect the needs of the product managers and directly tie customer importance with feature development and maintenance.

At step 780, the received data is added to feature use data store 360. In one embodiment, the data is aggregated with the data received from other customers. A decision is made as to whether there are more customers from which to request usage data (decision 790). If there are more customers from which to request usage data, then decision 790 branches to the “yes” branch which loops back to select the next customer from install base data store 700 and request and receive the customer's usage data as described above. This looping continues until the data has been gathered from all of the customers of the software offering, at which point decision 790 branches to the “no” branch and processing ends at 795.

FIG. 8 is a flowchart showing steps performed in gathering usage data from customers using a “push” methodology. Software provider feature usage access module processing 450 running at the customer installation commences at 825 based upon the data push settings. For example, the data could be pushed to the software provider at a particular time interval (e.g., hourly, daily, every five minutes, etc.) or can be pushed when a particular amount of data has been gathered in local feature usage data store 470 (e.g., when one record has been gathered, ten records gathered, etc.). At step 830, the software provider feature usage access module selects usage fields from data access restrictions data store 475. Data access restrictions data store 475 is a list of those usage access fields that are restricted from being sent to the software provider. For example, the usage data may gather the user identifiers of the users that execute various software modules included in the software offering and the customer may not wish to share this more personal information with the software provider. However, the customer may wish the retain this sensitive information locally as it may be useful for internal tracking and also in order to contact its users that have been shown to utilize software features (modules) that are scheduled to be eliminated or have reduced support. At step 840, the usage access module dumps previously un-gathered usage data from the local usage data store 470 to a customer usage data store 870 according to the customer's data access restrictions (e.g., refraining from sending user identifiers to the software provider, etc.). At step 850, the usage access module cleans out the local feature usage data store 470 or otherwise marks those data records that have already been transmitted to the software provider in order to reduce or eliminate duplicate data from being sent to the software provider. At step 860, the usage access module running on the customer's installation sends customer usage data store 870 to the software provider (e.g., over computer network 200, such as the Internet).

Processing performed at the software provider's site 340 is shown commencing at step 875 when the software provider receives the usage data that was gathered at the customer's installation and has been redacted based on the customer's data access restrictions. As previously described with regard to FIG. 7, in one embodiment, the data received by the customer is “weighted” based upon some criteria important to the software provider, such as the strategic value, or importance, of the customer to the software provider. In this embodiment, the weighting value could be automatically computed based upon customer support revenue or “net new license revenue over some time period”. In this manner, if one strategic customer is using a feature, product management would not want to remove it and the weighting value received from customer weighting values data store 885 would add value to the data stored in feature usage data store 470.

At step 880, the received data is added to central feature use data store 360. In one embodiment, the data is aggregated with the data received from other customers. At step 890, the software provider's process waits for the next data to be pushed from a customer installation to the software provider. When the next data is received, processing loops back to step 875 to receive and aggregate the data in central feature use data store 360.

FIG. 9 is a flowchart showing steps performed by product development and maintenance in response to the collected customer usage data. This routine is performed after the usage data has been collected from the customer installations, aggregated into the central usage data store, and product feature (module) usage statistics have been calculated. Processing commences at 600 whereupon, at step 905, the process selects the first feature of the software offering from product features data store 640. As previously mentioned, product features data store 640 includes a list of all of the product features that comprise the software offering as well as noting which product features (modules) are essential (e.g., required, etc.) for the product offering. A decision is made as to whether the selected product feature is essential to the software offering (decision 910). If the feature is essential, then decision 910 branches to the “yes” branch whereupon, at step 915, the feature is automatically included in product development and maintenance plan 685 for future development and continued maintenance. Processing then bypasses the remaining steps until decision 990.

On the other hand, if the product is not essential to the software offering, then decision 910 branches to the “no” branch whereupon, at step 925, usage statistics are retrieved pertaining to the selected feature (module) from product feature usage statistics data store 670. At step 930 the retrieved usage statistics for the product feature (module) are compared with thresholds that have been established by the software provider and stored in thresholds data store 940.

A decision is made, based on the comparison at step 930, as to whether usage of the selected software feature is so low as to warrant discontinuation of the feature (decision 950). For example, if few if any users utilize the selected feature, then the feature may be flagged for discontinuation (e.g., less than one percent usage, etc.). If the comparison reveals that the feature should be marked for discontinuation, then decision 950 branches to the “yes” branch whereupon, at step 955, the feature is marked in product development and maintenance plan data store 685 for possible discontinuation. Processing then bypasses the remaining steps until decision 990.

Returning to decision 950, if the comparison of the thresholds with the usage statistics does not fall within the “discontinue” threshold, then decision 950 branches to the “no” branch whereupon a decision is made as to whether the selected software feature is low enough as to warrant reduced support of the feature (decision 960). For example, only a small number of users utilize the selected feature, then the feature may be flagged for reduced support (e.g., fewer than ten percent of users utilize the feature, etc.). If the comparison reveals that the feature should be marked for reduced support, then decision 960 branches to the “yes” branch whereupon, at step 965, the feature is marked for reduced support in product development and maintenance plan data store 685 (e.g., no new development of the feature, little or no maintenance of the feature, etc.). Processing then bypasses the remaining steps until decision 990.

Returning to decision 960, if the comparison of the thresholds with the usage statistics does not fall within the “discontinue” or the “reduce support” thresholds, then decision 960 branches to the “no” branch whereupon a decision is made as to whether the selected software feature is high enough to warrant increased development of the feature (decision 970). For example, the software provider may find that a large number of users are utilizing a particular feature. Because of the feature's popularity, the software provider may decide to devote more resources to further developing and maintaining the feature. If the comparison reveals that the feature should be marked for further development, then decision 970 branches to the “yes” branch whereupon, at step 975, the feature is marked for increased development in product development and maintenance plan data store 685. Processing then bypasses the remaining steps until decision 990. If the comparison of the thresholds does not fall within the “discontinue,” the “reduce support,” or the “active development” thresholds then, in one embodiment, the feature is not marked in the product development and maintenance plan with decision 970 branching to the “no” branch and bypassing step 975. Software providers can add additional thresholds or reduce the number of thresholds described above.

After the selected product feature has been processed as described above, a decision is made as to whether there are more product features (modules) included in the software product offering that need to be processed (decision 990). If there are more product features (modules) included in the software product offering that need to be processed then decision 990 branches to the “yes” branch which loops back to select and process the next product feature as described above. This looping continues until all of the product features have been processed, at which point decision 990 branches to the “no” branch and processing returns to the calling routine (see FIG. 6) at 995.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method implemented by an information handling system comprising:
gathering one or more items of usage data pertaining to a plurality of instrumented software modules that are included in a software offering, wherein the usage data is gathered from a plurality of customer installations of the software offering;
computing one or more usage statistics corresponding to the plurality of the instrumented software modules; and
determining a support level corresponding to the plurality of instrumented software modules based upon the usage statistics pertaining to the corresponding instrumented software modules.

2. The method of claim 1 further comprising:
implementing a software development plan based upon the determined support levels of the instrumented software modules.

3. The method of claim 2 further comprising:
retrieving a plurality of usage thresholds;
comparing a first of the usage thresholds with each of the usage statistics computed for each of the plurality of instrumented software modules;
recommending each of the plurality of instrumented software with a corresponding usage statistic that falls below the first usage threshold for discontinuation;
comparing a second of the usage thresholds with each of the usage statistics computed for each of the plurality of instrumented software modules; and
recommending each of the plurality of instrumented software with a corresponding usage statistic that falls below the second usage threshold for reduced maintenance.

4. The method of claim 1 wherein one or more of the customer installations include the software offering installed on one or more customer computer systems, wherein the gathering transmits the usage data from the customer computer systems to a provider computer system via a computer network.

5. The method of claim 4 wherein the gathering further comprises:
storing local usage data pertaining to customer usage of the instrumented software modules installed at the customer computer systems in a data store local to each of the customer computer systems; and
transmitting the stored local usage data from each of the customer computer systems to the provider computer system via the computer network.

6. The method of claim 5 wherein the transmitting of the stored local usage data is pushed from each of the client computer systems to the provider computer system.

7. The method of claim 5 wherein the transmitting of the stored local usage data is pulled by the provider computer system from each of the client computer systems.

8. The method of claim 5 further comprising:
selecting one or more usage data fields at each of the customer installations, wherein the selection is based on a customer-controlled data restriction filter stored at one or more of the customer installations, and wherein the usage data fields include module identifier that identifies the module that was executed and a timestamp that identifies a date/time that the module was executed; and
transmitting the local usage data corresponding to the selected usage data fields from each of the customer installations based upon the respective customer-controlled data restriction filters.

9. The method of claim 1 further comprising:
retrieving a customer weighting value corresponding to one or more of the customer installations, wherein the customer weighting values reflect an importance of the one or more customer installations to the software provider; and
applying the retrieved customer weighting values to the usage data.

10. A method implemented by an information handling system comprising:
detecting execution of a plurality of software modules included in a software offering;
recording, in a local data store, one or more usage statistics pertaining to each of the detected executions of the software module, wherein one of the usage statistics is a plurality of module identifiers that identify each of the executed software modules, and wherein the usage statistics track a number of times each of the plurality of software modules was executed at the information handling system;
periodically transmitting the recorded usage statistics over a computer network to a software provider.

11. The method of claim 10 further comprising:
filtering the usage statistics based on one or more customer data access restrictions prior to transmitting the usage statistics over the computer network.
